(19) United States
(12) Patent Application Publication
(10) Pub. No.: US 2004/0011479 A1
(43) Pub. Date: Jan. 22, 2004

(54) Protective covering device for machinery or equipment

(75) Inventor: Fulvio Bissolo, Laives (IT)

Correspondence Address: Richard J. Minnich, Esq., Fay, Sharpe, Fagan, Minnich & McKee, LLP, Seventh Floor, 1100 Superior Avenue, Cleveland, OH, 44114-2518, US

(73) Assignee: P.E.I. PROTEZIONI ELABORAZIONI INDUSTRIALI S.r.L.

(21) Appl. No.: 10/619,885

(22) Filed: Jul. 15, 2003

(30) Foreign Application Priority Data
Jul. 17, 2002 (IT) BO2002A000459

(51) Int. Cl. E06B 9/00

(52) U.S. Cl. 160/223

(57) ABSTRACT

A protective covering device for machinery and equipment equipped with a mobile tool (3) that moves along a defined vertical path (D) comprises a set of cover elements (6, 7, 8, 9) slidably coupled to each other and consisting of a fixed first cover element (6), and a plurality of mobile cover elements (7, 8, 9) that move relative to each other; each of the cover elements (6, 7, 8, 9) having an opening (6a, 7a, 8a, 9a) defined by two longitudinal portions (10) and two transversal portions (11, 12), the latter together defining two complementary portions (13, 14) of a covering wall (15), and being positioned on opposite sides of the tool (3). In both the complementary portions, each transversal portion (11, 12) of each cover element (6, 7, 8, 9) comprises a section (12, 19) that overlaps the next section (12, 19) in tile-like fashion in a single direction (A) along the defined path (D), in such a way that all the sections (12, 19) of the covering wall (15) face the same direction (A).

### BACKGROUND OF THE INVENTION

The present invention relates to a protective covering device for machinery and equipment.

In particular, the invention concerns a protective covering device for the working parts of automatic machines, machine tools or robotized systems, and can be advantageously applied to several industrial sectors.

The present specification refers, but without thereby restricting the scope of the invention, to the sector of machine tools, where machine components require effective protection from chippings, swarf, dust and other process waste.

Italian patent application No.BO99U000053 in the name of the same Applicant as the present discloses a protective covering device for the working tool of a machine tool. The working tool moves in a straight line in both directions and the protective covering device is designed to follow its movements in such a way as to cover and protect the part of the machine from which the working tool itself projects.

The device comprises a plurality of relatively thin cover panels, which overlap each other and the first of which is fixed to the machine at the zone to be protected, while the other panels can slide relative to one another and relative to the first panel, in the same direction as that in which the working tool moves. The sliding of the mobile panels is guided by two guide profiles of the first panel which have a C-shaped cross section and which extend lengthwise in the direction of movement of the tool.

Each cover panel has a rectangular opening through which the mobile tool passes. More specifically, the opening in the first panel forms an area to be covered by the remaining mobile panels, whilst the openings in the mobile panels decrease in size starting from the one that faces the first panel. The cover panel in the outermost position, that is to say, the one opposite the fixed first panel in the set of mobile panels, is attached to and drawn by the mobile tool along the above mentioned straight path, whilst each of the other mobile panels is drawn along by a contact tab on the mobile panel adjacent to it on the outside.

Thus, as the mobile tool moves along its working path, the mobile panels in the different working positions cover corresponding, rectangular portions of the area defined by the opening in the first panel.

The overall thickness of the device described above is very limited. Each panel comprises a first section and a second section, lying longitudinally opposite each other in the same plane and connected by two longitudinal portions parallel to the tool feed path, in such a way as to form the boundary of the respective opening.

When fitted together, the panels making up the covering device slide over each other, and the two sets of first panel sections and second panel sections form two complementary portions, respectively first and second portions, of a covering wall. More specifically, the first and second sections are positioned on opposite sides of the tool along the tool feed path and overlap each other in tile-like fashion in opposite directions in such a way as to form two sets of panel sections that are symmetrical about the tool.

It is also known that in machine tools of the type under consideration, the working parts are cooled and lubricated by spraying fluid lubricants and coolants onto the tool from above. Obviously, these fluids also strike the wall of the protective cover which, owing to its particular structure, does not guarantee a perfect seal.

The present invention has for an object to provide a protective covering device that overcomes the drawback mentioned above with reference to prior art.

### SUMMARY OF THE INVENTION

Accordingly, the present invention provides a protective covering device for machinery and equipment equipped with a mobile tool that moves along at least one defined path; the device being attached to the tool and comprising a set of cover elements slidably coupled to each other and consisting of a first cover element attached to the machine or piece of equipment at an area to be protected, and a plurality of mobile cover elements that move relative to each other and relative to the first cover element along the defined path; each cover element having an opening defining, on each cover element and with reference to the defined path, two longitudinal portions and two transversal portions, the latter two defining for each cover element and relative to the tool a first section and a second section, the set of first sections and the set of second sections defining, respectively, a first portion and a second portion of a covering wall, said portions, which are complementary, being positioned on opposite sides of the tool, wherein, in both of these complementary portions, each section overlaps the next section in tile-like fashion in a single direction along the defined path.

### BRIEF DESCRIPTION OF THE DRAWINGS

The invention will now be described with reference to the accompanying drawings which illustrate a preferred embodiment of it and in which:

FIG. 1 is a perspective view of the covering device according to the present invention;

FIG. 2 is an exploded view of the device of FIG. 1;

FIG. 3 is a side view in cross section of the device of FIG. 1;

FIG. 4 is a side perspective view, with parts cut away, of the device of FIG. 1 in a different working position;

FIG. 5 is a side view in cross section of another embodiment of the device of FIG. 1.

### DESCRIPTION OF THE PREFERRED EMBODIMENTS

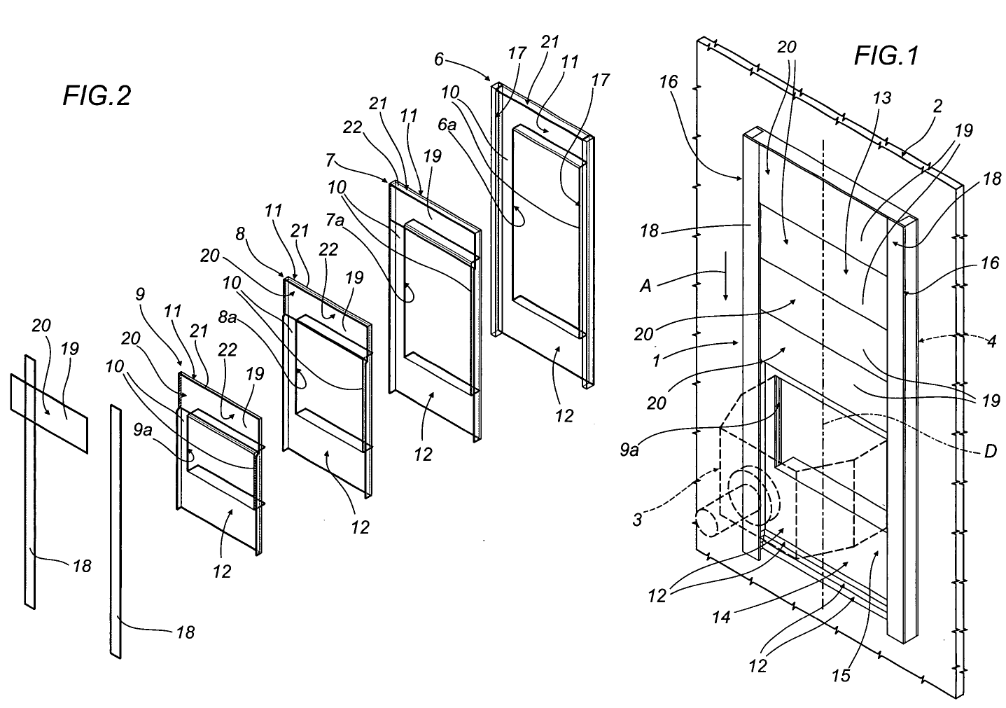

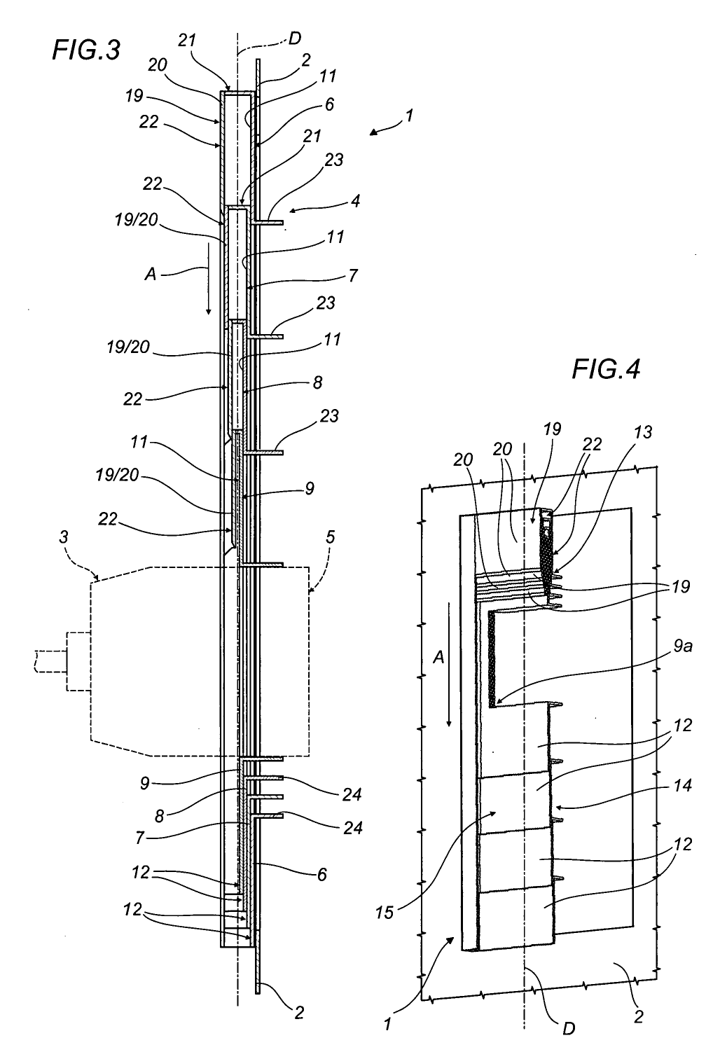

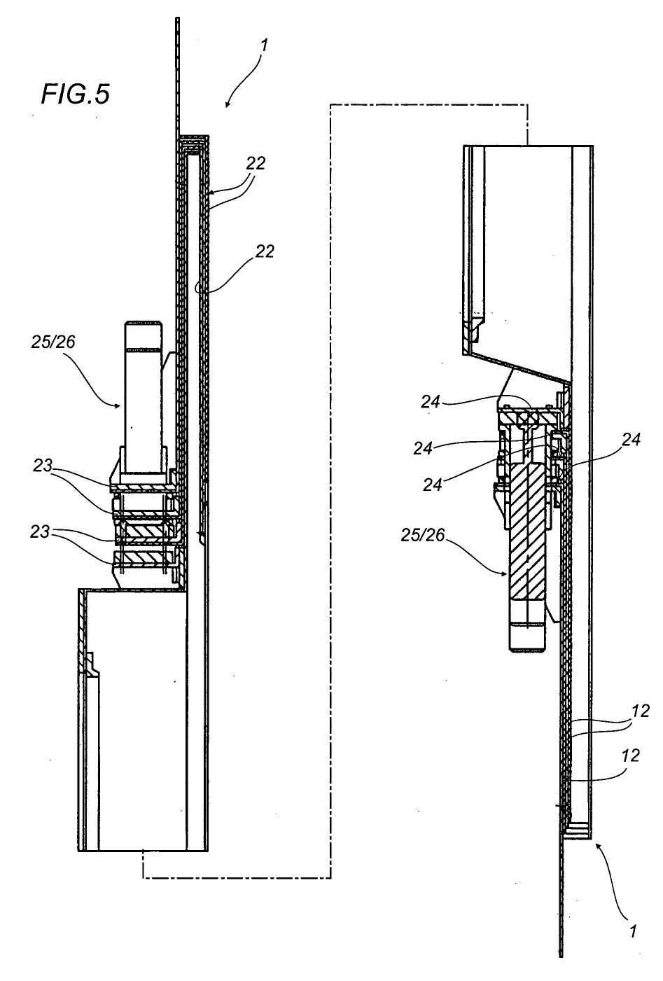

With reference to FIGS. 1 to 4, the numeral 1 denotes a protective covering device for a machine tool, of which only a part of a front wall 2 is illustrated and which comprises a working element 3 that moves in both directions along a substantially vertical path D and that is illustrated schematically by the dashed line in FIGS. 1 and 3.

The working element 3 is normally a tool forming part of a machine tool or similar machine and the protective covering device 1 is attached to the tool 3 in such a way as to follow the latter's backward and forward motion along the path D, covering and protecting a corresponding area 4 of the machine tool. Looking in more detail, the tool 3 has a rear portion 5 and projects from the protective covering device 1.

As illustrated in FIGS. 2 and 3, the device 1 comprises a set of cover elements which are slidably linked to each other and which consist of a first cover element 6 attached (in a way that is not illustrated) to the wall portion 2 of the machine at the area 4 to be protected, and a plurality of mobile cover elements 7, 8 and 9 that move relative to each other and relative to the fixed first cover element 6 along the path D.

The cover elements 6, 7, 8, 9 are made preferably of metal—for example steel—and consist of respective flat panels which are relatively thin, overlap each other and are substantially rectangular in shape. More specifically, the element 9 is positioned in contact with the element 8 which is positioned in contact with the element 7. The latter is positioned in contact with the element 6 which is attached to the front wall 2 of the machine.

The elements 6, 7, 8 and 9 are all substantially the same in width, transversal to the path D, whilst lengthwise, in a direction parallel to the path D, they gradually decrease in size starting from the fixed first element 6 down to the last mobile cover element 9.

Each cover element 6, 7, 8 and 9 has a substantially rectangular, central opening labelled, respectively, 6a, 7a, 8a and 9a, each defined by two longitudinal portions 10 and two transversal portions 11 and 12 which, with reference to the accompanying drawings, are the upper transversal portions 11 and the lower transversal portions 12 of the cover elements 6, 7, 8 and 9. In their entirety, the upper transversal portions 11 and the lower transversal portions 12 form, respectively, a first portion 13 and a second portion 14 of a covering wall 15.

Besides the respective panel, the element 6 comprises a device 16 for guiding and retaining the mobile elements 7, 8 and 9. The device 16 comprises two tracks 17 each extending in a direction parallel to the path D along an outside edge of the longitudinal portions 10 of the panel constituting the first element 6 itself. More specifically, each track 17 is formed by the respective outside longitudinal edge which transversely contains the mobile cover elements 7, 8 and 9, these being held together in a pack by a pair of strips 18 mounted on the longitudinal edges and protruding from the latter towards the inside of the covering wall 15.

The openings 6a, 7a, 8a and 9a are all substantially the same in width, at right angles to the path D, whilst lengthwise, in a direction parallel to the path D, they gradually decrease in size starting from the one in the fixed first element 6 down to the one in the last mobile cover element 9. Thus, during the movement of the tool 3 long the path D, the first portion 13 and the second portion 14 of the covering wall 15, complement each other and the wall 15 itself has an opening that coincides with the opening 9a in the element 9, through which the tool 3 protrudes.

In particular, the upper transversal portions 11 and the lower transversal portions 12 are in contact with each other and are drawn by the tool 3 as the latter moves along the path D. More specifically, the upper transversal portions 11 and the lower transversal portions 12 overlap each other starting from the cover element 6 and ending at the cover element 9, and proceeding outwards from the inside of the front wall 2 of the machine tool, the extent to which each element overlaps the next varying according to the position of the tool 3.

According to the present invention, since the protective covering device 1 is mounted vertically on the front wall 2 of the machine tool, the path D is substantially vertical and in both the first portion 13 and the second portion 14 of the covering wall 15, the transversal portions 11 and 12 of each cover element 6, 7, 8 and 9 comprise a first section and a second section, respectively. In particular, the second sections forming the second portion 14 of the covering wall 15 coincide with the transversal portions 12 of the cover elements and each lies in the same plane as the respective longitudinal portions 10 of each of the cover elements 6, 7 8 and 9. In this case, the second sections are labeled 12, like the transversal portions 12 they coincide with.

The first sections of the first portion 13 (the upper one) of the covering wall 15, on the other hand, are labeled 19 and consist of second portions 20, which are transversal to the path D and parallel to the transversal portions 11 to which they are associated, as illustrated in FIGS. 2 and 3, through connecting walls 21 which are also transversal to the path D and perpendicular to the portions 20 and 11. It should be noticed that the first sections 19 coincide with the second transversal portions 20.

Thus, along its full length, consisting of its upper portion 13 and its lower portion 14, on opposite sides of the tool 3, the covering wall 15 is defined by a succession of sections 20, 12, each overlapping the next section 20, 12 in tile-like fashion in the same direction, labeled A, along the path D, in such a way that all the sections 20 and 12 of the covering wall 15 face the same direction like the tiles of a roof.

More specifically, it follows from the above description that the overlapping direction A of each section 20, 12 of the two portions 13 and 14 is from the top down so as to prevent any coolant, washing liquid or lubricant sprayed onto the tool 3 from an area above the wall 2 from getting into the protected area 4.

With reference to FIGS. 2, 3 and 4, it should be noticed that in the upper portion 13 of the covering wall 15, for each first section 19, the set consisting of the respective second transversal portion 20, the transversal parallel portion 11, and the respective connecting wall 21 defines, for each cover element 6, 7, 8 and 9, a U-shaped box-like element 22.

The box-like elements 22 of the cover elements 6, 7, 8 and 9 are therefore telescopically coupled with each other.

As illustrated, in FIGS. 2, 3 and 4, besides the respective panel, each of the cover elements 6, 7, 8, 9 comprises first and second flanges 23, 24 located at the transversal edges opposite the corresponding openings 6a, 7a, 8a, 9a and extend at right angles from the respective panels on the same side as the area 4 to be protected.

The flanges 23 and 24 of each mobile cover element 7, 8, 9 constitute flanges for engaging with and stopping the adjacent covering element in such a way as to draw the cover elements along the path D and to stop them at an end of stroke position.

To lessen the impact between contiguous flanges, shock absorbing devices 25 consisting of energy dissipators are fitted between the flanges themselves, each being mounted in a fixed position on the respective flange.

Each of the devices 25, as described in European patent application EP n.02425257.9 dated 22.04.2002, the disclosure of which is incorporated herein by reference, comprises a pair of energy dissipating elements 26 designed to reduce the speed of the cover elements as they close in on each other, without returning energy between the elements themselves.

It will be understood that the invention can be modified and adapted in several ways without thereby departing from the scope of the inventive concept. Moreover, all the details of the invention may be substituted by technically equivalent elements. For example, the energy dissipating devices 26 can be substituted by shock absorbing pads made of flexible, resilient material.

What is claimed is:

1. A protective covering device for machinery and equipment equipped with a mobile tool (3) that moves along at least one defined path (D); the device (1) being attached to the tool (3) and comprising a set of cover elements (6, 7, 8, 9) slidably coupled to each other and consisting of a first cover element (6) attached to the machine or piece of equipment at an area (4) to be protected, and a plurality of mobile cover elements (7, 8, 9) that move relative to each other and relative to the first cover element (6) along the defined path (D); each of the cover elements (6, 7, 8, 9) having an opening (6a, 7a, 8a, 9a) defined, on each element (6, 7, 8, 9) and with reference to the defined path (D), by two longitudinal portions (10) and two transversal portions (11, 12), the latter two defining a first and a second portion (13, 14) of a covering wall (15), the portions (13, 14), which are complementary, being positioned on opposite sides of the tool (3), wherein, in that in both the first and second portions (13, 14) of the covering wall (15), each transversal portion (11, 12) of each cover element (6, 7, 8, 9) comprises a section (12, 19) that overlaps the next section (12, 19) in tile-like fashion in a single direction (A) along the defined path (D), in such a way that all the sections (12, 19) of the covering wall (15) face the same direction (A).

2. The device according to claim 1, wherein the overlapping direction (A) of each section (12, 19) of the two portions (13, 14) of the covering wall (15) is from the top down.

3. The device according to claim 2, wherein the path (D) is substantially vertical.

4. The device according to any of the foregoing claims from 1 to 3, wherein, in the second portion (14) of the covering wall (15), the respective second sections (12) coincide with the transversal portions (12) of each of the cover elements (6, 7, 8, 9) and lie in the same plane as the longitudinal portions (10) of the respective cover elements (6, 7, 8, 9), and in the first portion (13) of the covering wall (15) the respective first sections (19) consist of second transversal portions (20) parallel to the respective transversal portions (11) to which they are associated through connecting walls (21) transversal to the path (D) and perpendicular to the two transversal portions (20, 11).

5. The device according to claim 4, wherein, for each first section (19), the respective second transversal portion (20), first transversal portion (11) and connecting wall (21) form a U-shaped box-like element (22); the box-like elements (22) constituting the first sections (19) of the cover elements (6, 7, 8, 9) being telescopically coupled with each other.

6. The device according to any of the foregoing claims, further comprising shock absorbing means (25) fitted between the cover elements (6, 7, 8, 9).

7. The device according to any of the foregoing claims, further comprising energy dissipating means (25, 26) for reducing the speed of two adjacent consecutive elements (6, 7, 8, 9) as they approach each other without returning energy between the two elements (6, 7, 8, 9) themselves.
